(19) United States
(12) Patent Application Publication
(10) Pub. No.: US 2015/0211084 A1
(43) Pub. Date: Jul. 30, 2015

(54) METAL PROCESSING METHOD AND METAL PRODUCT PROCESSED THEREBY

(71) Applicants: Katsunori Ishiguro, Toyota-shi (JP); Kiyohito Kondo, Toyota-shi (JP); Takayuki Suzuki, Toyota-shi (JP); Masaki Furuhashi, Toyota-shi (JP)

(72) Inventors: Katsunori Ishiguro, Toyota-shi (JP); Kiyohito Kondo, Toyota-shi (JP); Takayuki Suzuki, Toyota-shi (JP); Masaki Furuhashi, Toyota-shi (JP)

(73) Assignee: AISIN TAKAOKA CO., LTD., Aichi (JP)

(21) Appl. No.: 14/389,244

(22) PCT Filed: Mar. 29, 2012
(86) PCT No.: PCT/JP2012/058437

§ 371 Date: Feb. 12, 2015

(51) Int. Cl. C21D 1/34; B05D 7/14; B05D 5/06; B32B 15/01; C21D 1/70; C21D 9/00; B23K 28/00; H05B 3/00; B05D 3/02; C21D 1/18

(52) U.S. Cl. CPC C21D 1/34; B05D 3/0263; B05D 7/14; B05D 5/063; C21D 1/18; C21D 1/70; C21D 9/0068; B23K 28/00; H05B 3/0061; B32B 15/01; B32B 2250/02

(57) ABSTRACT

A metal processing method using a tailored blank material as a raw material comprises: preliminarily bonding together a metal material having a relatively high heating rate by infrared heating and a metal material having a relatively low heating rate by infrared heating, to form an integrated metal material; and a-heating step the integrated metal material, wherein infrared heating of the integrated metal material is performed by infrared simultaneously and comprehensively; and in the integrated metal material undergoing the infrared heating, the infrared heating is terminated after a portion having the relatively high heating rate reached a predetermined temperature corresponding to a predetermined heat treatment and before a portion having the relatively low heating rate reaches the predetermined temperature.

### TECHNICAL FIELD

The present invention relates to a metal processing method and a metal product processed thereby, especially a metal processing method using a tailored blank material formed by welding a plurality of different kinds of metal materials and a metal product processed thereby.

### BACKGROUND

In Patent Document 1, for an infrared heating device, proposed is a method that a plate material having a predetermined pattern is arranged between infrared lamps and a material to be heated so that a predetermined heating intensity distribution is formed in the material to be heated.

In Patent Document 2, for a steel sheet to be die-quenched, proposed is a method that a portion in which strength of a steel sheet is required is quenched locally, preserving a portion in which corrosion prevention of the steel sheet is required.

In claim 1 of Patent Document 3, it is described as follows. “On a part of a metal sheet surface performing radiation heat-transfer heating, any treatment selected from a group consisting of paint, concavo-convex process, metallic coating, coloring processing by immersion to an acidic solution, etching, or immersion by nickel chloride hexahydrate solution is processed, and a reflectance of some radiant rays on the part of the metal sheet surface is reduced.” In Patent Document 3, paragraph 0017, as a surface treatment method of reducing reflectance, there is a description of black-colored painting, black-colored plating processing and black-colored thermal spray. In Patent Document 3, paragraph 0033, it is described as follows. “As compared with a tailored blank method for giving partially different strength: first welding different-type metal sheets to form a tailored metal sheet, next, processing this sheet, according to the method relating the exemplary embodiment, preliminary metal sheet processing and welding are unnecessary, and there is no need to use plural kinds of materials. For this reason, a manufacturing cost becomes cheap. Moreover, although position and number of a weld line as a strength-transition part were restricted by the above tailored blank method, there is no restriction in the exemplary embodiment, and a free-shaped different strength portion can be formed in a free position by performing reflectance reduction process with masking in a free position.”
[Patent Document 1] Japanese Patent No. 4575976
[Patent Document 2] Japanese Patent Kokai Publication No. JP2009-22995A
[Patent Document 3] Japanese Patent Kokai Publication No. JP2011-152589A (refer to paragraph 0033)

### SUMMARY

The entire disclosures of the above Patent Documents 1, 2 and 3 are incorporated herein by reference thereto. The analysis is set forth below by the present invention.

When a heat treatment is performed using the plate material of Patent Document 1, there is a case to require an exchange of the plate material according to types or forms of the material to be heated; thus, it causes a problem that the heat treatment requires time and effort and is costly. Moreover, there is a possibility that time, effort and cost are needed for setting a boundary line between a portion with predetermined heat treatment and a portion without predetermined heat treatment.

To quench the steel sheet locally as disclosed in Patent Document 2, for example, when contacting an electrode onto the portion which requires quenching of a blank material and performing a conducting (ohmic) heating, depending on conditions, other portions of the blank material are not fully heated, and there is a possibility to decrease a moldability.

According to the invention of Patent Document 3, a starting material which is a target of heat treatment or hot stamp processing is restricted inherently to ones that has been subjected to a partial surface treatment for reducing surface reflectance on one metal sheet, and it is denied to use a tailored blank material.

It is an object of the present invention to provide a metal processing method which can simplify equipment and process management required for metal processing by using a tailored blank material as a starting material, and a metal product processed thereby.

In a first aspect of the present invention, there is provided a metal processing method comprising: preliminarily bonding together a metal material having a relatively high heating rate by infrared heating and a metal material having a relatively low heating rate by infrared heating, to form an integrated metal material; and a heating the integrated metal material, wherein infrared heating is performed on the integrated metal material by infrared simultaneously and comprehensively; and in the integrated metal material undergoing the infrared heating, the infrared heating is terminated after a portion having the relatively high heating rate has reached a predetermined temperature corresponding to a predetermined heat treatment and before a portion having the relatively low heating rate reaches the predetermined temperature.

In a second aspect of the present invention, there is provided a metal product according to the first aspect of the present invention.

The effects of the present invention are exemplified below. By using the tailored blank material which can be easily manufactured only by bonding, as a starting material, time and effort and cost concerning the manufacture of the metal product are reduced. Moreover, since a desired characteristic distribution can be formed in a product by arranging metal materials having different properties in a predetermined pattern and by preliminarily bonding such metal materials, an equipment for heat treatment, process management of heat treatment, etc. can be simplified.

### BRIEF DESCRIPTION OF THE DRAWINGS

FIG. 1 illustrates an explanatory drawing of an infrared heating device which can be used by a metal processing method relating an example of the present invention,

FIGS. 2 A-2C illustrate plan views of a metal material (tailored blank material) adopted by a metal processing method relating an example of the present invention,

FIG. 3 illustrates a graph showing a result of infrared heating of two metal materials having different heating rates, adopted by a metal processing method relating an example of the present invention.

### PREFERRED MODES

According to an exemplary embodiment of the present invention, a portion treated with the predetermined heating treatment is allocated by a metal material having a relatively high heating rate and a portion not treated with the predetermined heating treatment is allocated by the metal material having a relatively low heating rate. According to this embodiment, the amount of energy used for heating can be reduced. Therefore heat conduction from the portion having the relatively high heating rate to the portion having the relatively low heating rate decreases, so that a boundary where the property of the metal material changes can be provided clearly. In other words, by arranging metal materials having different properties in a predetermined pattern and preliminarily bonding (joining) such metal materials, the boundary between the portion treated with the predetermined heat treatment and the portion treated without the predetermined heat treatment can be provided easily and precisely. In a formation stage of blank material (bonding stage of a plurality of metal materials), for example, since it is set that a high portion having strong strength and a low portion having weak strength can be separately formed, an equipment of heat treatment or management (control) for heat treatment can be simplified. For example, by using the tailored blank material which can be easily manufactured only by bonding, as a start material, a partial quenching becomes possible.

As to heating temperature difference between the metal material having the relatively high heating rate and the metal material having the relatively low heating rate, it is preferable to adjust composition of metal material(s), surface nature(s) thereof, or three-dimensional shape(s) thereof such as size or thickness so that the temperature difference between both materials is preferably 100 to 400 degrees C., more preferably 100 to 300 degrees C., further more preferably 150 to 250 degrees C., when the metal material having the relatively high heating rate reaches to a preset temperature for heat treatment. Preferably, the heating rate difference is 5 to 30 degrees C./s, more preferably 5 to 20 degrees C./s, further more preferably 5 to 15 degrees C./s.

According to an exemplary embodiment of the present invention, in the heating, the portion having the relatively high heating rate and the portion having the relatively low heating rate are infrared heated with the same (or similar) irradiation condition. According to this embodiment, equipment for heat treatment and process management for heat treatment can be simplified. In addition, since it is not necessary to mask the portion treated without the predetermined heat treatment, it can be unnecessary to perform exact positioning of material to be treated. Accordingly, since the portion to heat and the portion to suppress heating are set by using material properties, the equipment for heat treatment or management (control) of heat treatment can be simplified.

According to an exemplary embodiment of the present invention, in the heating, the portion having a relatively low heating rate is infrared heated without covering this portion. According to this embodiment, equipment of heat treatment and process management for heat treatment can be simplified.

According to an exemplary embodiment of the present invention, in the bonding, the metal material having the relatively high heating rate and the metal material having the relatively low heating rate are bonded by welding. According to this embodiment, the material to be treated with heating treatment can be obtained easily by welding.

According to an exemplary embodiment of the present invention, the metal material having the relatively high heating rate is heated to a quenching temperature or more, and the metal material having the relatively low heating rate is heated to a temperature less than the quenching temperature. According to this embodiment, an amount of energy used for heating can be reduced. Moreover, the quenched portion having high strength can be manufactured separately from the unquenched portion having low strength.

According to an exemplary embodiment of the present invention, the heating rate difference is set by any one or more selected from composition(s) of the metal material, surface treatment(s) of the metal material and three-dimensional form(s) of the metal material. For example, a predetermined heat treatment can be performed, improving heating efficiency by using a light-absorptive paint. Moreover, overheating of a portion to which a light-reflective paint has been applied can be prevented by using the light-reflective paint.

According to an exemplary embodiment of the present invention, bright plating is performed on the metal material having a relatively low heating rate so that the metal material having the relatively low heating rate has an infrared reflectance higher than that of the metal material having a relatively high heating rate. According to this embodiment, since it is prevented to heat more than the predetermined heat treatment temperature, for example the quenching temperature for the portion with bright plating, it is easy to form the portion with bright plating, and after forming, it can economize or simplify the corrosion prevention treatment for the portion applied with bright plating and formed. In addition, since the portion with bright plating is maintained relatively at a low temperature at the time of heat treatment, dripping of plating is prevented. As a kind of bright plating, nickel plating, zinc plating, alloyed hot-dip zinc plating, molten aluminum plating, chrome plating, tin plating, gold plating, silver plating, copper plating, and various alloy platings are exemplified.

According to an exemplary embodiment of the present invention, the heating temperature of the integrated metal material is adjusted with output adjustment of infrared lamps. According to this embodiment, it is possible to shorten heating time for elevating temperature and reduce an amount of energy required for elevating temperature.

According to an exemplary embodiment of the present invention, the integrated metal material is infrared heated from both sides of the material. According to this embodiment, it is possible to shorten heating time for elevating temperature.

A metal processing method relating an exemplary embodiment of the present invention comprises forming the integrated metal material after finishing the heating, and cooling the integrated metal material during the forming or after finishing the forming. According to this embodiment, the heated material is easy to form.

Preferably, in the infrared heating, infrared rays having various wavelengths can be used. The wavelength of the infrared ray irradiation is set, depending on the property of the metal material used.

As metal materials having different heating rates caused by the infrared heating, followings are exemplified: metal materials having differences in thickness, width, or three-dimensional form, main composing elements, carbon contents, added or not-added with quenching-reinforced metal, plated metal material and metal material without being plated, steel sheet or special steel sheet such as stainless steel sheet, those applied with a paint having high absorptive amount of the infrared ray having a specific wavelength, and those applied with a paint having high reflective amount of the infrared ray having a specific wavelength or not etc.

As described in the above, the heating rate difference can be also set by bonding metal materials having mutually different surface properties. For example, it can be set by bonding metal materials having different unevenness (or roughness), degrees on surfaces thereof, on bonding metal materials having different degrees of mirror surface.

For example, in the bonding, materials having mutually different heating rate caused by infrared heating are selected according to property distribution needed for a final product, and such materials can be bonded by welding. Bonding (or joining) under pressure such as rolling, or bonding with rivets can be chosen as bonding besides welding.

At a stage of the bonding, a partial heating rate difference (distribution) to be required in the next heating, exists potentially in the integrated metal. Therefore, in the next heating, simultaneous and overall infrared heating can be performed.

According to an exemplary embodiment of the present invention, in the integrated metal material during infrared heating, in the case where after the portion having a relatively high heating rate has reached a quenching temperature and before the portion having a relatively low heating rate reaches at this quenching temperature; that is, at a stage that reaches a temperature at which sufficient formability is obtained, the infrared heating is terminated.

The heated metal material can be cooled simultaneously with forming caused by die-quenching, and also be rapidly-cooled after press-forming (molding).

Metal products according to the present invention are suitably used as automobile components such as B pillar reinforcement (center pillar reinforcement), a door impact beam, and a side member.

### EXAMPLES

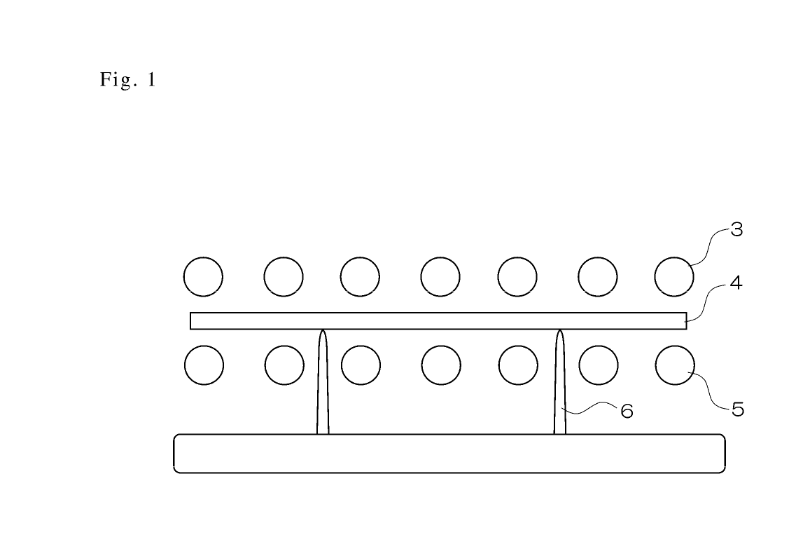

An example of the present invention is explained in the below, with reference to Figures. FIG. 1 is an explanatory drawing of an infrared heating device which can be used by a metal processing method relating an example of the present invention.

Referring to FIG. 1, a metal material 4 is provided which has been pre-bonded and integrated from a metal material having a relatively high heating rate and a metal material having a relatively low heating rate (herein below, it is called as “tailored blank material”). The tailored blank material 4 is heated from both sides thereof by near infrared lamps 3 arranged above the tailored blank material 4 and near infrared lamps 5 arranged below the tailored blank material 4. In addition, the tailored blank material 4 is provided on a work supporting rod 6 so as not to contact with the near infrared lamps 3 and 5.

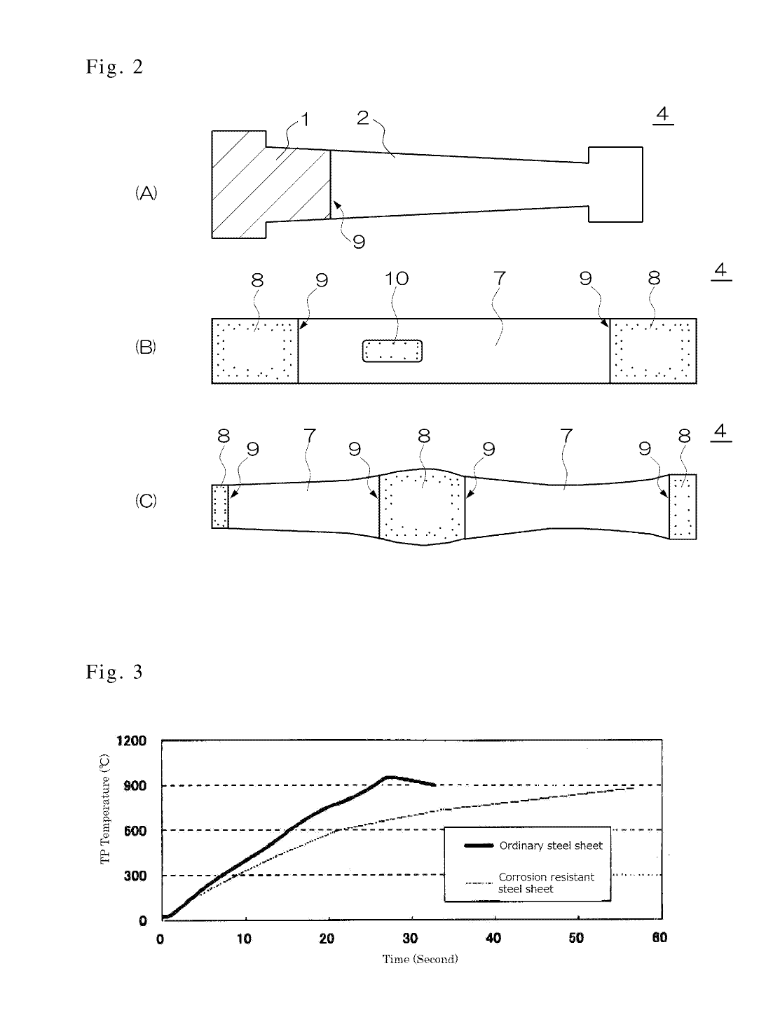

Next, an example of the tailored blank material adopted by the metal processing method relating an example of the present invention is explained. FIGS. 2A to 2C illustrate plan views of the tailored blank material adopted by the metal processing method relating an example of the present invention.

Referring to FIG. 2A, the metal material having a relatively low heating rate 1 and a metal material having a relatively high heating rate 2 are welded at a weld-bonding site 9 to form the tailored blank material 4. For example, by adopting a corrosion resistant steel sheet as the metal material 1 and a steel sheet for hot-press forming (molding) as the metal material 2, it is configured that a heating rate of the metal material 2 is higher than that of the metal material 1. Accordingly, in a heating, when the metal material 2 reaches a quenching temperature, the metal material 1 does not reach this quenching temperature. Through the heating, forming and cooling, the tailored blank material 4 shown in FIG. 2A is utilized as a framework member such as a B pillar reinforcement of a vehicle.

Referring to FIG. 2B, as to a rectangular tailored blank material 4, corrosion resistant steel sheets 8, 8 are welded at weld-bonding sites 9, 9 on both edges of an ordinary steel sheet 7. In addition, a reflective paint 10 is applied on a center portion of the ordinary steel sheet 7. Since an infrared absorptivity of the ordinary steel sheet 7 is higher than that of the corrosion resistant steel sheet 8, the ordinary steel sheet 7 is configured as a portion having a relatively high heating rate, and the corrosion resistant steel sheet 8 is configured as a portion having a relatively low heating rate. In addition, in the ordinary steel sheet 7, since an infrared reflectance is higher than other portions, as for the portion to which the reflective paint 10 was applied, the portion applied with the reflective paint 10 is also configured as a portion having a relatively low heating rate. In the tailored blank material 4 shown in FIG. 2B, the portion of the ordinary steel sheet 7 (with a proviso excluding the portion applied with the reflective paint 10) is made into high-strength by quenching, whereas a formability (moldability) is kept without quenching in the portion of the corrosion resistant steel sheet 8 and the portion applied with the reflective paint 10 on the ordinary steel sheet 7. For example, as for the portion applied with the reflective paint 10 on the ordinary steel sheet 7, puncturing process etc. is easily applied thereto. Accordingly, the tailored blank material 4 which is heated, formed and cooled is preferably used as a door impact beam.

Moreover, instead of the reflective paint 10, applying an absorptive paint which is easy to absorb infrared rays, the portion applied with the absorption paint is locally heated, and quenched and made into high strength.

In addition, in the case where quenching is also required for the portion of corrosion resistant steel sheet 8, both the portion of the ordinary steel sheet 7 and the portion(s) of the corrosion resistant steel sheet 8 may be heated to a temperature of at least an austenitizing temperature, by increasing an output of the infrared lamps.

Referring to FIG. 2C, the tailored blank material 4 is formed by bonding materials of different shapes and in detail, a corrosion resistant steel sheet 8, an ordinary steel sheet 7, a corrosion resistant steel sheet 8, an ordinary steel sheet 7, and a corrosion resistant steel sheet 8 are welded in this order, at respective weld-bonding sites 9. Since the infrared absorptivity of the ordinary steel sheet 7 is higher than that of the corrosion resistant steel sheet 8, the ordinary steel sheet 7 is configured as a portion having a relatively high heating rate and the corrosion resistant steel sheet 8 is configured as a portion having a relatively low heating rate. In the tailored blank material 4 shown in FIG. 2C, the portions of the ordinary steel sheet 7 are made into high-strength by quenching, whereas the formability (moldability) is kept without quenching for the portions of corrosion resistant steel sheet 8.

FIG. 3 illustrates a graph showing a result of infrared heating of two metal materials having different heating rates, adopted by the metal processing method relating an example of the present invention. Referring to FIG. 3, during a time period (0 to 28 seconds) when the ordinary steel sheet reaches the maximum temperature, the heating rate of the ordinary steel sheet shown in heavy line was 32 degrees Celsius per second and the heating rate of the corrosion resistant plated steel sheet shown in dotted line was 23 degrees Celsius per second, thus a heating rate difference between the both was about 10 degrees Celsius. At a time when the ordinary steel sheet reached the maximum temperature (at a time 28 seconds after starting the heating step), a temperature difference between the ordinary steel sheet and the corrosion resistant plated steel sheet was 250 degrees Celsius. In addition, it is recognized that in a time period for approximately 20 to 40 seconds after the heating start, the portion of the ordinary steel sheet having a relatively high heating rate reaches a sufficient quenching temperature, and the portion of the corrosion resistant plated steel sheet having the relatively low heating rate does not reach the quenching temperature.

According to experimental results mentioned above, due to infrared heating of an integrated tailored blank material by bonding an ordinary steel sheet having a relatively high heating rate and a corrosion resistant plated steel sheet having a relatively low heating rate under the same condition simultaneously and entirely, followed by forming and cooling, it is found to be possible that the portion(s) made of the ordinary steel sheet is locally quench-hardened, whereas the portion(s) made of the corrosion resistant plated steel sheet is not quench-hardened, thus keeping corrosion resistant property or formability. That is, through the heated tailored blank material is press-formed simultaneously with cooling, a metal product is obtainable, which product has both properties of: the hardened portion treated with quench-hardening and the corrosion resistant portion not treated with quench-hardening.

In addition, as a combination of metal materials having different heating rate, a combination of a steel sheet and a corrosion resistant plated steel sheet with bright plating is practical. Since a reflectance of infrared light is increased by bright plating, the heating rate decreases compared with the ordinary steel sheet without bright plating, dripping of plating is prevented and a quenching for the portion with bright plating is suppressed; accordingly, formability (moldability) is maintained. As a kind of bright plating, there are nickel plating, zinc plating, alloyed hot-dip zinc plating, molten aluminum plating, chrome plating, tin plating, gold plating, silver plating, copper plating, and various alloy plating.

It should be noted that changes and modifications of the modes or Examples may be done within the entire disclosure (inclusive of each element of respective claims, each element of respective example and each element of respective figures etc.) of the present invention and on the basis of the basic technical concept thereof. Also, it should be noted that a variety of combinations or selections of various elements as disclosed in each exemplary embodiment, each Example and each Figure may be made within the scope of the claims of the present invention. That is, it should be noted that the present invention also includes various changes and modifications which can be made by a person skilled in the art on the basis of all the disclosure inclusive of the claims and technical concept.

### EXPLANATION OF SYMBOLS

1 metal material having a relatively low heating rate
2 metal material having a relatively high heating rate
3 near infrared lamp
4 tailored blank material
5 near infrared lamp
6 work supporting rod
7 ordinary steel sheet (normal steel sheet)
8 corrosion resistant steel sheet (antirust steel sheet)
9 weld-bonding site
10 reflective paint applying site

1. A metal processing method, comprising:
preliminarily bonding together a metal material having a relatively high heating rate by infrared heating and a metal material having a relatively low heating rate by infrared heating, to form an integrated metal material; and
a heating the integrated metal material, wherein infrared heating is performed on the integrated metal material by infrared simultaneously and comprehensively; and in the integrated metal material undergoing the infrared heating, the infrared heating is terminated after a portion having the relatively high heating rate has reached a predetermined temperature corresponding to a predetermined heat treatment and before a portion having the relatively low heating rate reaches the predetermined temperature.

2. The metal processing method as defined in claim 1, wherein a portion treated with the predetermined heating treatment is allocated by the metal material having the relatively high heating rate and a portion not treated with the predetermined heating treatment is allocated by the metal material having the relatively low heating rate.

3. The metal processing method as defined in claim 1, wherein in the heating step, the portion having the relatively high heating rate and the portion having the relatively low heating rate are infrared heated under a same irradiation condition.

4. The metal processing method as defined in claim 3, wherein in the heating step, the portion having the relatively low heating rate is infrared heated without shielding this portion.

5. The metal processing method as defined in claim 1, wherein in the bonding, the metal material having the relatively high heating rate and the metal material having the relatively low heating rate are bonded by welding.

6. The metal processing method as defined in claim 1, wherein the metal material having the relatively high heating rate is heated to a quenching temperature or more, and the metal material having the relatively low heating rate is heated to a temperature less than the quenching temperature.

7. The metal processing method as defined in claim 1, wherein the heating rate difference is set by any one or more selected from composition of the metal materials, surface treatment of the metal materials and three-dimensional forms of the metal materials.

8. The metal processing method as defined in claim 1, wherein bright plating is performed on the metal material having the relatively low heating rate so that infrared reflectance of the metal material having the relatively low heating rate is higher than that of the metal material having the relatively high heating rate.

9. The metal processing method as defined in claim 1, wherein the heating temperature of the integrated metal material is adjusted with output adjustment of an infrared heating lamp(s).

10. The metal processing method as defined in claim 1, wherein the integrated metal material is infrared heated from both sides thereof.

11. The metal processing method as defined in claim 1, comprising:
forming the integrated metal material after finishing the heating, and
cooling the integrated metal material during the forming or after finishing the forming.

12. A metal product processed by the metal processing method as defined in claim 1.
